(19) United States
(12) Patent Application Publication
(10) Pub. No.: US 2024/0023523 A1
(43) Pub. Date: Jan. 25, 2024

(54) METHOD FOR POLYCULTURE OF ALOSA SAPIDISSIMA AND MACROBRACHIUM ROSENBERGII BY FLOATING NET FISHING DEVICE UND GREENHOUSE EARTHEN POND

(71) Applicant: Freshwater Fisheries Research Center,Chinese Academy of Fishery Sciences, Wuxi City (CN)

(72) Inventors: Gangchun XU, Wuxi City (CN); Zhijuan NIE, Wuxi City (CN); Nailin SHAO, Wuxi City (CN); Yao ZHENG, Wuxi City (CN); Jiancao GAO, Wuxi City (CN); Yi SUN, Suzhou City (CN); Haojun ZHU, Wuxi City (CN); Jinliang DU, Wuxi City (CN); Liping CAO, Wuxi City (CN); Jun GAO, Wuxi City (CN); Quanjie LI, Wuxi City (CN); Jiawen HU, Wuxi City (CN)

(21) Appl. No.: 18/225,915

(22) Filed: Jul. 25, 2023

(30) Foreign Application Priority Data
Jul. 25, 2022 (CN) 2022108777287

(51) Int. Cl. A01K 61/10; A01K 61/59; A01K 61/80

(52) U.S. Cl. CPC A01K 61/10; A01K 61/59; A01K 61/80

(57) ABSTRACT

A method for polyculture of Alosa sapidissima and Macrobrachium rosenbergii by a floating net fishing device and a greenhouse earthen pond includes: S1: providing a slope on an inner wall of a pond, and providing a feeding channel on the slope for survival and attachment of the Macrobrachium rosenbergii; S2: building a greenhouse on the pond, raising a water temperature to a set temperature, then putting Macrobrachium rosenbergii larvae, and putting Alosa sapidissima fry into the pond for polyculture in different periods; and S3: fishing in batches through a floating net: firstly, fishing the Alosa sapidissima fry in middle and upper layers, and then fishing the Macrobrachium rosenbergii in middle and lower layers.

### TECHNICAL FIELD

The application relates to the field of culture, and in particular to a method for polyculture of Alosa sapidissima and Macrobrachium rosenbergii by a floating net fishing device and a greenhouse earthen pond.

### BACKGROUND

Alosa sapidissima, also known as American shad, is usually cultured in an earthen pond with a greenhouse. After June, the Alosa sapidissima fry are put in the pond, the water temperature is kept at 16-30 degree Celsius (° C.) suitable for growth the fry, so as to make the fry overwinter safely. The bigger the Alosa sapidissima fry, the higher the price, and the more difficult transportation. The purchased Alosa sapidissima fry have usually a size of 3-5 cm, and it usually takes 18 months for the Alosa sapidissima fry to grow to the commercial specification of 650-750 gram (g). Moreover, the Alosa sapidissima fry are domesticated in groups and are used to compete fiercely for bait, so they need to be cultured in a high density in the early stage, and then are divided and put into different ponds for culture at the end of that year, otherwise the low density of the fry leads to scattered fish, uneven feeding and large growth speed difference, which is not conducive to commercial culture. At the fry stage of the Alosa sapidissima, the utilization rate of pond space is usually low, and it is often necessary to heat the pond water after winter to maintain the water temperature needed for the survival and growth of the Alosa sapidissima fry, so the cost is high, and it is necessary to reasonably match suitable high-efficiency breeding varieties to make full use of time and space, reducing the heating cost and improve the income.

Macrobrachium rosenbergii is a subtropical shrimp, typical thermophilic species, and has strong sensitivity to water temperature. The water temperature suitable for the growth of larvae of the Macrobrachium rosenbergii is 18-30° C., so the Macrobrachium rosenbergii stocked in the past year must be fished before the water temperature drops to 18° C. after being cultured in summer and autumn. At this time, limited by water temperature, Macrobrachium rosenbergii is usually on the market concentratively. And due to the short growth time and small sizes of some Macrobrachium rosenbergii, the bad cycle of low purchase price and low income is triggered. Therefore, extending survival and growth period of the Macrobrachium rosenbergii and delaying time to market to the high-priced consumption period in the New Year have become the focus of farmers' attention.

To sum up, the problems existing in the prior art are as follows: 1. the Alosa sapidissima fry are usually stocked in June-July, but the pond is vacant before the fry are stocked namely from March to June, and in the early stage of stocking the fry, the fry are small, so the fish pond cannot be fully utilized, wasting resources; 2. the smaller the sizes of the fry, the longer the breeding period and the later the time to market; 3. during the culture of the Alosa sapidissima, some fish dies of illness and sinks to the bottom, and a large number of harmful bacteria are produced by microbial decomposition, which is easy to cause fish diseases. 4. during the breeding period, the Alosa sapidissima competes for food, and part of the feed sinks to the bottom of the water as the Alosa sapidissima competes for dispersion, resulting in the gradual accumulation of residual bait, which leads to the waste of feed, and the decomposition of residual bait produces various pollutants; 5. when the Alosa sapidissima overwinters, the water must be kept at a certain temperature, but the cost of greenhouse and heating is high; 6. the culture pond of the Alosa sapidissima usually doesn't have the slope needed by Macrobrachium rosenbergii culture, so it needs to be reformed properly. 7. Macrobrachium rosenbergii is harvested in autumn, cannot survive and grow in water below 18° C. and must be transferred into the greenhouse soil pool to prevent sudden cooling and mass death; 8. Macrobrachium rosenbergii is usually on the market concentratively, but some Macrobrachium rosenbergii have small sizes, resulting in bad cycle of low purchase price and low income; 9. Macrobrachium rosenbergii can't be caught by traditional shrimp cages without entering the cages, but only be caught by pulling nets, but traditional nets cause accidental injury to the delicate Alosa sapidissima; 10. the Alosa sapidissima belongs to pelagic fish, and is caught with a floating net, which is different from Macrobrachium rosenbergii. It is necessary to catch Alosa sapidissima fry first and then Macrobrachium rosenbergii.

### SUMMARY

An objective of the present application is to provide a method for polyculture of Alosa sapidissima and Macrobrachium rosenbergii by a floating net fishing device und a greenhouse earthen pond, which makes full use of different living water layers and feeding habits of the Alosa sapidissima and the Macrobrachium rosenbergii to carry out complementary polyculture, reduce the breeding cost and maintain a virtuous cycle to increase income.

To achieve the above objective, the present application adopts a following technical scheme.

A method for polyculture of Alosa sapidissima and Macrobrachium rosenbergii by a floating net fishing device und a greenhouse earthen pond includes following steps:
S1: providing a slope on an inner wall of a pond, and providing a feeding channel on the slope for survival and attachment of the Macrobrachium rosenbergii;
S2: building a greenhouse on the pond, raising a water temperature to a set temperature, then putting Macrobrachium rosenbergii larvae, and putting Alosa sapidissima fry into the pond for polyculture in different periods; and
S3: fishing in batches through a floating net: firstly, fishing the Alosa sapidissima fry in middle and upper layers, and then fishing the Macrobrachium rosenbergii in middle and lower layers.

In an embodiment, in the S1, the slope is arranged in a ring-shaped closed-loop connection manner; inclining from top to bottom, the slope is divided into an upper slope, a platform layer and a lower slope; the platform layer is provided with the feeding channel for feeding the Macrobrachium rosenbergii; plants for water purification are planted on the upper slope.

In an embodiment, in the S2, the greenhouse is arranged on the pond, the water temperature of the pond is kept between 22-28° C., then soybean milk and EM bacteria are respectively mixed with the water and sprinkled into the pond, and an amount of zooplankton in the water is regularly observed; then the Macrobrachium rosenbergii larvae after inspection and quarantine are put into the pond after adapting to water temperature treatment.

In an embodiment, in the S3, winches are arranged at both ends of the pond along a length direction of the pond, and traction ropes on the winches arranged symmetrically are connected with both ends of the floating net; the floating net is laid on the pond, and the floating net is partially submerged in water; the winches drive the floating net to move back and forth in the pond through the traction ropes to fish the Alosa sapidissima fry or the Macrobrachium rosenbergii.

In an embodiment, the floating net is arranged in a frame type, and end faces of the both ends of the floating net are telescopic net surfaces; when fishing, a telescopic net surface on a side in a moving direction of the floating net is opened, while a telescopic net surface on an other side is closed.

In an embodiment, when fishing, the floating net is divided into an upper layer and a lower layer; when fishing the Alosa sapidissima fry, the lower layer of the floating net is contracted, and the floating net catches the Alosa sapidissima fry in the middle and upper layers during movement; when fishing the Macrobrachium rosenbergii, the lower layer of the floating net is spread to a bottom of the pond, and the floating net catches the Macrobrachium rosenbergii in the middle and lower layers in the pond during the movement.

In an embodiment, both sides of the upper layer of the floating net are symmetrically provided with expansion sections; the expansion sections are communicated with an inside of the floating net; the expansion sections and the floating net form a stepped structure; a bottom each of the expansion sections is arranged next to a surface of the platform layer, and side walls of the expansion sections are net surfaces; the expansion sections move synchronously with the floating net; two ends each of the expansion sections are respectively provided with a vibrating device, and the vibrating device makes the net surfaces of the expansion sections oscillate and vibrate, being vibrating net surfaces; the vibrating net surfaces at the both ends are respectively arranged on same sides corresponding to the telescopic net surfaces.

In an embodiment, the bottom each of the expansion sections is provided with a folding net; the folding net is triangular; the folding net is located at a position of the lower slope, and a hypotenuse of the folding net is arranged to adapt to a surface of the lower slope; bottoms of folding nets are fixedly connected with side walls of the bottom of the floating net; when the lower layer of the floating net is folded, the lower layer of the floating net drives the folding nets connected with both sides of the lower layer of the floating net to be folded at a same time; when the lower layer of the floating net is unfolded, the lower layer of the floating net drives the folding nets connected with the both sides of the lower layer of the floating net to unfold at a same time.

In an embodiment, an edge of the folding net is provided with a protruding net surface; the protruding net surface is attached to the surface of the lower slope; when the folding net move, the folding net drags the protruding net surface attached to the surface of the lower slope to move.

The embodiments of the application have following effects.

Based on the traditional greenhouse earthen pond for culture of the Alosa sapidissima, the application introduces the Macrobrachium rosenbergii, a famous variety with economic characteristics, for the first time, and makes full use of different living water layers and feeding habits of the Macrobrachium rosenbergii and the Alosa sapidissima to carry out complementary polyculture, increase space utilization efficiency, cultivate large-sized Macrobrachium rosenbergii larvae and large-sized Alosa sapidissima fry in advance, shorten the breeding period of the Alosa sapidissima, prolong the marketing period of Macrobrachium rosenbergii, improve the utilization efficiency of bait and reduce the spread of breeding pathogens.

### BRIEF DESCRIPTION OF THE DRAWINGS

FIG. 1 is a flowchart of a method for polyculture of Alosa sapidissima and Macrobrachium rosenbergii by a floating net fishing device und a greenhouse earthen pond.

FIG. 2 is a schematic diagram of pond reconstruction.

FIG. 3 is an exploded view of a slope.

FIG. 4 is a schematic diagram of a floating net.

FIG. 5 is a schematic structural diagram of expansion sections.

### DETAILED DESCRIPTION

The present application is further described with reference to the drawings.

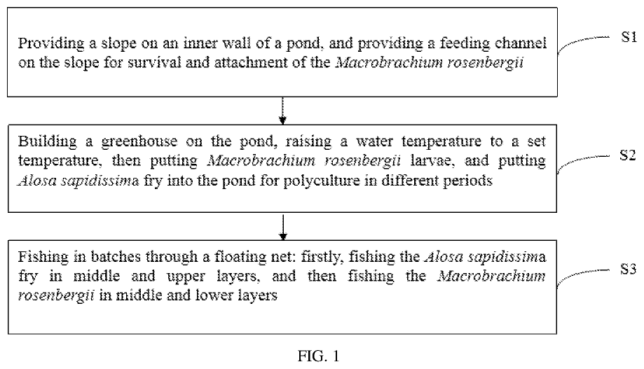

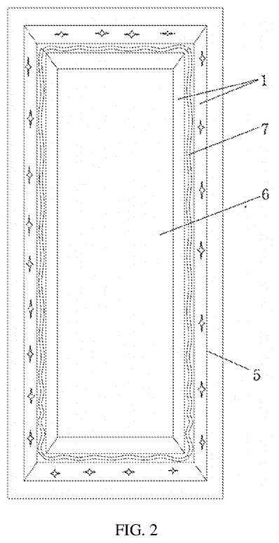

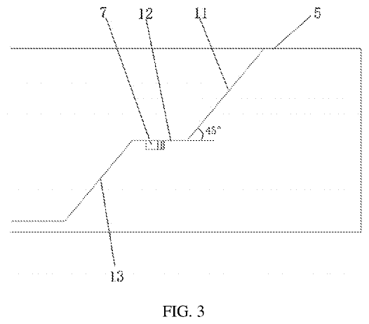

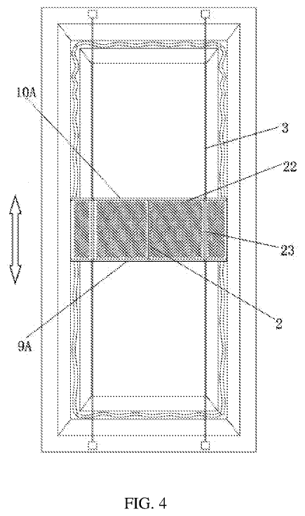

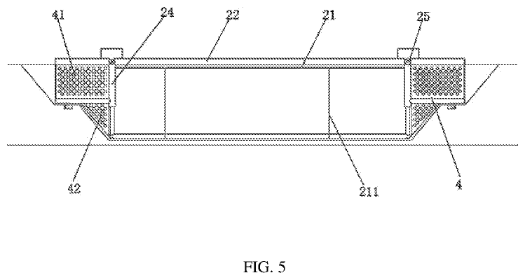

As shown in FIG. 1, FIG. 2, FIG. 3, FIG. 4 and FIG. 5, a method for polyculture of Alosa sapidissima and Macrobrachium rosenbergii by a floating net fishing device und a greenhouse earthen pond includes:
S1: a slope 1 is arranged on an inner wall of a pond, and a feeding channel 7 is arranged on the slope 1 for survival and attachment of the Macrobrachium rosenbergii;
S2: a greenhouse is built on the pond, water is heated to a set temperature, then Macrobrachium rosenbergii larvae are put into the pond, and Alosa sapidissima fry are put into the pond for the polyculture; and
S3: the Macrobrachium rosenbergii larvae and the Alosa sapidissima fry are fished in batches through the floating net 2, where the Alosa sapidissima fry in middle and upper layers are fished firstly, and then the Macrobrachium rosenbergii larvae in middle and lower layers are fished.

The slope 1 in the S1 is arranged in a ring-shaped closed-loop manner and is divided into an upper slope 11, a platform layer 12 and a lower slope 13 from top to bottom; the platform layer 12 is provided with a feeding channel 7 for feeding the Macrobrachium rosenbergii; aquatic plants for water purification are planted on the upper slope 11. As shown in a schematic diagram of pond reconstruction in FIG. 2, a traditional greenhouse earthen pond without the slope is reconstructed, and specifically, the slope 1 is arranged between a pond ridge 5 and a pond bottom 6, in which the slope 1 is an earthen slope and thereby has no influence on culture of the Alosa sapidissima in the middle and upper layers, the slope is helpful for microorganism adhesion to purify the water quality, the slope is arranged in the whole pool in a closed-loop manner and the closed-loop manner is beneficial to the flow of water, the slope provides a protection layer to the inner wall of the pond and prolongs an effective service life of the pond, the slope is provided with a feeding channel 7 in the middle, which is suitable for the survival and the attachment of the Macrobrachium rosenbergii, and the slope near the pond ridge is planted with the aquatic plants, so as to purify the water, protect the slope and provide shading shelter for the Macrobrachium rosenbergii; the slope is provided with the feeding channel 7 for feeding the Macrobrachium rosenbergii and is planted with the aquatic plants such as Ipomoea aquatica and Sagittaria trifolia to purify the water.

As shown in an exploded diagram of the slope in FIG. 3, a vertical height from the pond ridge to the pond bottom of the slope pond is 2.8 meter (m) and a slope width is 3 m. The earthen slope is divided into the upper slope, the feeding channel for the Macrobrachium rosenbergii on the platform layer and the lower slope; the upper slope is parallel to the lower slope, is the same length as the lower slope, and forms an included angle of 45° with the pond bottom; the feeding channel for the Macrobrachium rosenbergii is excavated between the upper slope and the lower slope, and the feeding channel is parallel to the pond bottom, has a width of 0.2 m, is wave-shaped and forms a ring-shaped closed-loop.

Seasonal culture is carried out according to the year and date.

### EMBODIMENT

In February, an existing pond was reconstructed as shown in FIG. 2 and FIG. 3; on February 10, the water in the pond was disinfected with quicklime according to 100 kilogram per mu (kg/mu), where 1 mu=666.6666667 square meters (m²); on February 20, the greenhouse was closed to raise the temperature, geothermal energy or steam provided by a power plant is used to gradually raise the water temperature to above 22° C., then every mu of pond is sprinkled with soybean powder liquid made of mixing 1 kg of soybean powder and 10 kg of water and EM bacterium every day, and the amount of zooplankton in water is regularly observed; at the beginning of March, the small Macrobrachium rosenbergii larvae about 1 centimeter (cm) long after inspection and quarantine were put into the pond after adapting to the water temperature in the pond according to 10,000-15,000 larvae/mu. The stocked Macrobrachium rosenbergii larvae mainly feeds on living zooplankton in the pond, with some artificial feed, so that the survival rate was improved and the feed cost was reduced. During the period, the feed, mainly sinking feed, was sprinkled in the feeding channel on the slope for the Macrobrachium rosenbergii larvae to feed themselves.

At the beginning of April, aquatic plants (Ipomoea aquatica and Sagittaria trifolia etc. germinating with roots cultivated in advance in the greenhouse) were planted in single row on the upper slope of the slope, and the earliest batch of the Alosa sapidissima fry with the size of 2-3 cm were purchased and cultured mixed with the Macrobrachium rosenbergii larvae according to 8,000-10,000 fry/mu; compared with the previous purchase of the Alosa sapidissima fry in June-July, the Alosa sapidissima fry were put into the pond for cultivation 2-3 months in advance, the whole culture cycle was advanced 2-3 months, and the time for adult fish to leave the pond was generally advanced 2-3 months. From ultra-high density cultivation in a traditional small cement pond to a large earthen pond, with the expansion of living space, the density of the fry decreased and the growth of the fry became faster. At this time, the fry may directly eat the living zooplankton cultivated for the Macrobrachium rosenbergii, so the survival rate increases. The Macrobrachium rosenbergii is omnivorous, and some Alosa sapidissima fry are injured in transportation, die and then sink to the pond bottom after entering the pond, and finally become food of the Macrobrachium rosenbergii to prevent breeding of fish diseases. The Alosa sapidissima fry are domesticated in groups, and compete fiercely for bait during the feeding period, so part of the bait is pushed to the shore by the rising splash of fish. The part of bait slowly sinks to the bottom of the water, slides down to the feeding channel of the Macrobrachium rosenbergii along the earthen slope and becomes the bait of Macrobrachium rosenbergii, which fully improves the utilization efficiency of the bait and avoids the destruction of water quality after the decomposition of residual bait.

In October, when the water temperature was about 22° C., firstly, the Alosa sapidissima fry in the middle and upper layers underwater within 1.5 m were fished by floating nets, and at this time, after 7 months of cultivation, the Alosa sapidissima fry were cultivated into 50-75 gram (g) heave fry for sale; or the adult fish was cultured in greenhouse earthen ponds according to the density of 2,500-3,000 fish/mu, grew to 0.6-0.75 kg in October of the following year and reached the commercial specification, which was 1-2 months ahead of the previous year. The market of the commercial fish catches up with the popular period of National Day and Mid-Autumn Festival for consumption in the next year, with high market demand and good price. Secondly, after the large Alosa sapidissima fry are fished, the Macrobrachium rosenbergii is fished by the floating net, and part of the fished Macrobrachium rosenbergii are sold at this time, so that on the one hand, part of the culture cost is recovered, and on the other hand, the culture density of the Macrobrachium rosenbergii is reduced, so as to culture large Macrobrachium rosenbergii in ponds. Thirdly, the water temperature is adjusted in a safety range above 22° C., compared with the traditional pond culture, the Macrobrachium rosenbergii can't continue to be cultured because of the water temperature limitation, so the Macrobrachium rosenbergii has to be on the market in a large scale, which leads to a bad market and a low price. But the Macrobrachium rosenbergii cultured in the greenhouse earthen pond may cope with the natural cooling in autumn and winter and may continue to grow. During the high consumption window period before the Spring Festival from December to February, the adult Macrobrachium rosenbergii is fished by floating nets gradually. At this time, the Macrobrachium rosenbergii has an average size over 120 g, is in short supply and may be sold at a high price. The greenhouse earthen pond is fully utilized to maximize utilization value and bring the highest added value.

In the S3, winches are arranged at both ends of the pond along a length direction of the pond, and traction ropes 3 on the winches arranged symmetrically are connected with both ends of the floating net 2; the floating net 2 is laid on the pond and partially submerged in the water; the winches drive the floating net to move back and forth in the pond through the traction ropes 3 to catch the Alosa sapidissima fry or the Macrobrachium rosenbergii. The main frame of the floating net is made of stainless steel and is connected and anchored with the traction ropes through stainless steel fixing rings 25; the winches on fixed pile of the pond control the movement of the traction ropes to realize the forward and backward movement of the floating net. A length of long rods 22 of the floating net is 15 m, a length of short rods 23 is 5 m, and vertical rods 24 are made of retractable material and are 1.5-2.5 m long. When the Alosa sapidissima fry are caught, the traction ropes are moved in two directions by controlling the winches on the fixed piles, and the traction ropes haul the floating net to move bidirectionally forward and backward to catch the Alosa sapidissima fry in the middle and upper layers. The floating net 2 is arranged in a frame type, and two end faces of the both ends of the floating net 2 are telescopic net surfaces 21; during fishing, a telescopic net surface 21 on a side in a moving direction of the floating net 2 is opened, while a telescopic net surface 21 on the other side is closed. When the floating net moves towards the winches and the fixed piles at one end of the pond, the Alosa sapidissima fry in the middle and upper layers enter the fish inlet on the 9A net surface, and at this time, the 9A net surface of the fish inlet is in a contraction state to facilitate the entry of fry, the 10B net surface of fish inlet is in an open state to avoid the fry from escaping. On the contrary, when the floating net moves towards the winches and the fixed piles at the other end of the pond, the Alosa sapidissima fry in the middle and upper layers enter the fish inlet on the 10B net surface, and at this time, the 10B net surface of the fish inlet is in a contraction state to facilitate the entry of fry, the 9A net surface of fish inlet is in an open state to avoid the fry from escaping. A top end each of the telescopic net surfaces is wound on one vertically corresponding long rod 22 at a top of the floating net, and rotating devices arranged at both ends each of the long rods 22 drive the long rods 22 to rotate, so that the telescopic net surfaces may be wound correspondingly, while a bottom end each of the telescopic net surfaces is connected by a rope 211 wound on the long rod 22 at the bottom of the floating net, and the long rods 22 at the top of the floating net and the long rods 22 at the bottom of the floating net are rotated in coordination to drive the telescopic net surfaces to be wound or unfolded.

The Alosa sapidissima fry in the middle and upper layers and the Macrobrachium rosenbergii larvae in the middle and lower layers in the pond are successively fished in batches.

When fishing, the floating net 2 is divided into an upper layer and a lower layer; when fishing the Alosa sapidissima fry, the lower layer of the floating net 2 is in a contraction state, and the floating net 2 catches the Alosa sapidissima fry in the middle and upper layers during the movement; when fishing the Macrobrachium rosenbergii, the lower layer of the floating net 2 is spread to the bottom of the pond, and the floating net 2 catches the Macrobrachium rosenbergii in the middle and lower layers of the pond. When the floating net is used to catch the Alosa sapidissima fry in the middle and upper layers of the pond within 1.5 m underwater, the length of vertical rod is 1.5 m. At this time, the large Alosa sapidissima fry are caught for sale or cultivation in different ponds. At the early stage of the Spring Festival in January, a height of the vertical rod is adjusted to 2.8 m, and the vertical rod includes a first section and a second section, where the first section is 1.5 m long and is arranged correspondingly to the upper layer of the floating net, and the second section is 1.3 m long and is arranged correspondingly to the lower layer of the floating net; the Macrobrachium rosenbergii fished by the floating net attached to the pond bottom is sold at high price.

Both sides of the upper layer of the floating net 2 are symmetrically provided with a expansion section 4 respectively; the expansion sections 4 are communicated with an inside of the floating net 2; the expansion sections 4 and the floating net 2 form a stepped structure; a bottom each of the expansion sections 4 is arranged next to a surface of the platform layer 12, and side walls of the expansion sections 4 are net surfaces; the expansion sections 4 move synchronously with the floating net 2; two ends each of the expansion sections 4 are respectively provided with a vibrating device, and the vibrating devices make the net surfaces of the expansion sections 4 oscillate and vibrate, being vibrating net surfaces 41; the vibrating net surfaces 41 at the both ends are respectively arranged on the same sides corresponding to the telescopic net surfaces 21. The expansion sections 4 move synchronously with the floating net 2 and correspondingly fill spaces above the platform layer 12; during fishing, the expansion sections 4 play a role in blocking the way of the Alosa sapidissima or the Macrobrachium rosenbergii, preventing the Alosa sapidissima or the Macrobrachium rosenbergii from escaping to both sides and avoiding incomplete fishing; in this way, the Alosa sapidissima or the Macrobrachium rosenbergii move to the fish inlets of the floating net 2 during fishing and the fishing efficiency is improved; moreover, the vibration of the vibrating net surfaces may disturb the Alosa sapidissima or the Macrobrachium rosenbergii and drive the Alosa sapidissima or the Macrobrachium rosenbergii to the middle of the pond, which is convenient for fishing; and the expansion sections expand the spaces on the both sides and thereby being convenient for accommodating the Alosa sapidissima or the Macrobrachium rosenbergii.

The bottom each of the expansion sections 4 is provided with a folding net 42; the folding net 42 is triangular; the folding net 42 is located at a position of the lower slope 13, and a hypotenuse of the folding net 42 is arranged adapted to a surface of the lower slope 13; bottoms of folding nets 42 are fixedly connected with side walls of the bottom of the floating net 2; side edges of the folding nets 42 are in contact with the side walls of the floating net 2; when the lower layer of the floating net 2 is folded or unfolded, the lower layer of the floating net 2 drives folding nets 42 connected with both sides of the lower layer of the floating net 2 to be folded or unfolded at a same time. Similarly, when fishing the Macrobrachium rosenbergii, the second section of the vertical rod is extended to make the lower layer of the floating net 2 close to the bottom of the pond, so that the floating net may fish the Macrobrachium rosenbergii in the middle and lower layers in the pond during the movement, but there are triangular gaps between the lower slope and the floating net, and some Macrobrachium rosenbergii escapes from the gaps without being blocked; therefore, the folding nets are arranged in the gaps, and when the lower layer of the floating net is unfolded, the folding nets are driven to unfold, further blocking the triangular gaps, preventing the Macrobrachium rosenbergii from escaping, facilitating complete fishing and improving the fishing efficiency. The folding nets are made of an elastic material, and an elastic band is arranged on the hypotenuse each of the folding nets, one end of the elastic band is connected with the bottom corresponding one of the expansion sections, and the other end of the elastic band is connected with the bottom of the second section of corresponding one of the vertical rods. On the one hand, the elastic band plays a role of folding. During folding the folding nets, the second section of the corresponding vertical rod drives the elastic band to be close to the bottom of the corresponding expansion section, and the elastic band just presses the net surface of the corresponding folding net on a bottom surface of the corresponding expansion section, thus reducing the occupied space of the folding net and avoiding affecting the fishing of the Alosa sapidissima. On the other hand, when the folding net is unfolded, the elastic band has enough toughness and a certain inclination angle, plays a certain tightening role and helps the folding net to fit the pool edge, so that the folding net plays a good role in blocking.

An edge each of the folding nets 42 is provided with a protruding net surface; the protruding net surface is attached to the surface of the lower slope 13; when the folding net 42 moves, the folding net 42 drags the protruding net surface attached to the surface of the lower slope 13 to move. Due to the elasticity of the elastic band, there is a certain gap between the elastic band and the lower slope, and the protruding net surface is arranged at the edge of the elastic band to fill the gap; when fishing the Macrobrachium rosenbergii, the protruding net surface is attached to the surface of the lower slope, which is convenient for the Macrobrachium rosenbergii to grasp without damaging Macrobrachium rosenbergii and improves the fishing efficiency. Moreover, the protruding net surface is dragged along the surface of the lower slope, and the protruding net surface is lightweight, and the contact surface between the protruding net surface and the bottom surface of the lower slope is non-planar. The side of the protruding net surface far from the elastic band is relatively free, and the force of the protruding net surface on the Macrobrachium rosenbergii on the lower slope is not great, so that the Macrobrachium rosenbergii is not damaged. For example, the Macrobrachium rosenbergii in the hole of the lower slope, the protruding net surface only touches the surface of the Macrobrachium rosenbergii and does not cause damage to the Macrobrachium rosenbergii).

### APPLICATION EMBODIMENT

In 2021-2022, experiments were carried out based on two earthen pond-greenhouse systems established in Xishan District, Wuxi City, Jiangsu Province, each greenhouse occupied about 5 mu. After the ecological transformation of the pond ridges, the Macrobrachium rosenbergii larvae with a size of about 1 cm were raised at the beginning of March, and in April, according to 8000-10000 fish/mu, Alosa sapidissima fry with a size of 2-3 cm were mixed with Macrobrachium rosenbergii for polyculture. By maintaining the growth of plants on slopes and ecological floating beds all the year round, combining with the aeration system, regular fertilization and microbial agents to adjust the water quality, the supply of biological bait is ensured and the water quality is kept good and stable. Macrobrachium rosenbergii and Alosa sapidissima fry estivate safely. At the end of the year, 30,000 large Alosa sapidissima fry of 50-75 g were successfully cultivated, transported by salty water, and stocked and cultured in other ponds according to a density of 3000-3,500 fry/mu, so as to obtain commercial Alosa sapidissima, and the commercial Alosa sapidissima is on the market in advance, so as to catch up with the peak consumption of Mid-Autumn Festival and National Day in the coming year and achieve a good harvest. After the Alosa sapidissima fry are caught by the floating net device, the telescopic rod of the floating net is adjusted, and the lower net is extended to 2.8 m, so as to fish the middle and lower layers of Macrobrachium rosenbergii. At this time, an average size each of the Macrobrachium rosenbergii is 15-20 kg, which is in time for the National Day and the Mid-Autumn Festival, so the Macrobrachium rosenbergii may be sold at a good price. The Macrobrachium rosenbergii with a larger size is sold first according to a principle of catching big fish and releasing small fish, and the Macrobrachium rosenbergii with a smaller size is fed by heating cultivation until the Spring Festival. The height of the vertical rod is adjusted to 2.8 m, the Macrobrachium rosenbergii is fished by the floating net attached to the pond bottom and then fished by draining pond water. The Macrobrachium rosenbergii caught and sold has bright color, compact meat, delicious taste and no muddy smell, with an average yield of 125 kg/mu and a maximum specification of 160 g/fish.

It should be understood that the technical schemes of the present application are not limited to the limits of the above specific embodiments, and any technical variations made according to the technical solutions of the present application, without departing from the scope protected by the objective and claims of the present application, fall within the scope of protection of the present application.

What is claimed is:

1. A method for polyculture of Alosa sapidissima and Macrobrachium rosenbergii by a floating net fishing device und a greenhouse earthen pond, comprising following steps:
S1: providing a slope on an inner wall of a pond, and providing a feeding channel on the slope for survival and attachment of the Macrobrachium rosenbergii;
S2: building a greenhouse on the pond, raising a water temperature to a set temperature, then putting Macrobrachium rosenbergii larvae, and putting Alosa sapidissima fry into the pond for polyculture in different periods; and
S3: fishing in batches through a floating net: firstly, fishing the Alosa sapidissima fry in middle and upper layers, and then fishing the Macrobrachium rosenbergii in middle and lower layers;
in the S3, winches are arranged at both ends of the pond along a length direction of the pond, and traction ropes on the winches arranged symmetrically are connected with both ends of the floating net; the floating net is laid on the pond, and the floating net is partially submerged in water; the winches drive the floating net to move back and forth in the pond through the traction ropes to fish the Alosa sapidissima fry or the Macrobrachium rosenbergii;
the floating net is arranged in a frame type, and end faces of the both ends of the floating net are telescopic net surfaces; when fishing, a telescopic net surface on a side in a moving direction of the floating net is opened, while a telescopic net surface on an other side is closed;
when fishing, the floating net is divided into an upper layer and a lower layer; when fishing the Alosa sapidissima fry, the lower layer of the floating net is contracted, and the floating net catches the Alosa sapidissima fry in the middle and upper layers during movement; when fishing the Macrobrachium rosenbergii, the lower layer of the floating net is spread to a bottom of the pond, and the floating net catches the Macrobrachium rosenbergii in the middle and lower layers in the pond during the movement.

2. The method for the polyculture of the Alosa sapidissima and the Macrobrachium rosenbergii by the floating net fishing device und the greenhouse earthen pond according to claim 1, wherein in the S1, the slope is arranged in a ring-shaped closed-loop connection manner; inclining from top to bottom, the slope is divided into an upper slope, a platform layer and a lower slope; the platform layer is provided with the feeding channel for feeding the Macrobrachium rosenbergii; plants for water purification are planted on the upper slope.

3. The method for the polyculture of the Alosa sapidissima and the Macrobrachium rosenbergii by the floating net fishing device und the greenhouse earthen pond according to claim 2, wherein in the S2, the greenhouse is arranged on the pond, the water temperature of the pond is kept between 22 and 28° C., then soybean milk and EM bacteria are respectively mixed with the water and sprinkled into the pond, and an amount of zooplankton in the water is regularly observed; then the Macrobrachium rosenbergii larvae after inspection and quarantine are put into the pond after adapting to water temperature treatment.

4. The method for the polyculture of the Alosa sapidissima and the Macrobrachium rosenbergii by the floating net fishing device und the greenhouse earthen pond according to claim 3, wherein both sides of the upper layer of the floating net are symmetrically provided with expansion sections; the expansion sections are communicated with an inside of the floating net; the expansion sections and the floating net form a stepped structure; a bottom each of the expansion sections is arranged next to a surface of the platform layer, and side walls of the expansion sections are net surfaces; the expansion sections move synchronously with the floating net; two ends each of the expansion sections are respectively provided with a vibrating device, and the vibrating device makes the net surfaces of the expansion sections oscillate and vibrate, being vibrating net surfaces; the vibrating net surfaces at the both ends are respectively arranged on same sides corresponding to the telescopic net surfaces.

5. The method for the polyculture of the Alosa sapidissima and the Macrobrachium rosenbergii by the floating net fishing device und the greenhouse earthen pond according to claim 4, wherein the bottom each of the expansion sections is provided with a folding net; the folding net is triangular; the folding net is located at a position of the lower slope, and a hypotenuse of the folding net is arranged to adapt to a surface of the lower slope; bottoms of folding nets are fixedly connected with side walls of the bottom of the floating net; when the lower layer of the floating net is folded, the lower layer of the floating net drives the folding nets connected with both sides of the lower layer of the floating net to be folded at a same time; when the lower layer of the floating net is unfolded, the lower layer of the floating net drives the folding nets connected with the both sides of the lower layer of the floating net to unfold at a same time.

6. The method for the polyculture of the Alosa sapidissima and the Macrobrachium rosenbergii by the floating net fishing device and the greenhouse earthen pond according to claim 5, wherein an edge of the folding net is provided with a protruding net surface; the protruding net surface is attached to the surface of the lower slope; when the folding net move, the folding net drags the protruding net surface attached to the surface of the lower slope to move.
